(19) United States
(12) Patent Application Publication
(10) Pub. No.: US 2026/0194702 A1
(43) Pub. Date: Jul. 9, 2026

(54) OPTICAL ELEMENT, OPTICAL SYSTEM AND VEHICLE WINDOW PANE AND/OR WINDOW PANE LAMINATE

(71) Applicant: Webasto SE, Stockdorf (DE)

(72) Inventors: Matthias Baumann, Stockdorf (DE); Robert Pasquarelli, Stockdorf (DE)

(21) Appl. No.: 19/127,610

(22) PCT Filed: Oct. 25, 2023
(86) PCT No.: PCT/EP2023/079803

§ 371 Date: May 6, 2025

(30) Foreign Application Priority Data
Nov. 15, 2022 (DE) 10 2022 130 204.0

(51) Int. Cl. F21V 8/00

(52) U.S. Cl. CPC G02B 6/0025; G02B 6/0016; G02B 6/003; G02B 6/0073

(57) ABSTRACT

The invention relates to an optical element (28), in particular an optical prism, comprising at least one light incoupling surface (32), a light guiding body (33) and at least one light outcoupling surface (34). The at least one light incoupling surface (32) comprises at least one light diffuser layer (35) and/or at least one double curvature.

The present invention relates to an optical element, in particular an optical prism, as claimed in the preamble of claim 1.

Optical elements of this type are used in vehicle construction, for example, and serve as light guiding structures in order that for example light emitted by a light source is redirected in a targeted manner and is incoupled for example into a light guide layer of a vehicle window pane and/or a window pane laminate. Optical elements of this type are often formed as optical prisms, which can be shaped in triangular and/or wedge-shaped fashion, for example. The use of the optical element enables a pose and/or positioning of a light source to be chosen freely, since a shaping of the optical element makes it possible to attain a predetermined deflection or redirection of the light, for example orthogonally to a main emission direction or a main incoupling direction of the light source. Moreover, known optical elements often serve to collimate, i.e. to parallelize or align, the light emitted by the light source in order in this way for example to attain a homogeneous light distribution during the light incoupling into the light guide layer. An efficiency of the light outcoupling from the optical element into the light guide layer is enhanced as a result.

The vehicle window pane and/or the window pane laminate illuminated by the provision of the light guide layer serve(s) in particular for interior lighting for a vehicle and/or some other space. In general, a multiplicity of light sources are provided, these being arranged at a distance from one another as LED strips, for example. In this case, at least one optical element can be assigned to at least one light source, thereby enabling light incoupling proceeding from the at least one light source into the at least one optical element, light guiding and/or light redirecting within the optical element and also light outcoupling from the optical element into a light guide layer.

It is likewise known, by providing a curvature on a light incoupling surface of the optical element, to obtain not only collimation of the light but additionally also light focusing along a predetermined axis. However, the light incoupling is restricted to a maximum possible incoupling angle on account of predetermined and/or material-dependent optical properties. This physical barrier is determined by the refractive index of the material, more precisely by the ratio of the refractive index of air to the refractive index of the material from which the optical element is produced. This is because starting from the maximum possible incoupling angle, total internal reflection occurs at the light incoupling surface. The known optical elements are often produced from PMMA (polymethyl methacrylate) or PPU (thermoplastic polyurethane), such that the maximum incoupling angle is restricted to 41° to 42° (measured with respect to an angle bisector).

In the case of known optical elements, this physical barrier has the effect that within the light guide layer into which the light is guided via the optical element, homogeneous light intermixing cannot be attained until at a late stage. Such light intermixing within the light guide layer occurs all the later, the further apart from one another the individual light sources are. Later light intermixing in turn leads to unwanted color differences during subsequent light outcoupling from the light guide layer, which are perceptible as optical disturbance variables. Even though reducing a distance between the individual light sources can rectify this problem, the disadvantage that arises as a result is that more light sources have to be used for this purpose. However, this leads to an increase in costs. In addition, more installation space is required, this being available only as a scarce resource particularly in the field of vehicles.

The disadvantages pointed out above need to be overcome. Therefore, it should be considered to be an object of the invention to further develop an optical element, in particular an optical prism, in such a way as to enable more homogeneous light intermixing and/or an increase in light scattering in at least one spatial direction.

The object is achieved by an optical element as claimed in claim 1.

The dependent claims relate to advantageous embodiments of the invention. All combinations of at least two features disclosed in the description, the claims and/or the figures fall within the scope of the invention. It is understood that the explanations given in relation to the optical element equivalently relate to the optical system according to the invention and/or the vehicle window pane according to the invention and/or the window pane laminate according to the invention, without being mentioned redundantly therefor. It is understood here in particular that idiomatic transformations and/or analogous substitution of respective terms in the context of customary linguistic practice, in particular the use of synonyms supported by the generally recognized linguistic literature, are encompassed by the present disclosure content, without being explicitly mentioned in their respective formulation.

The invention proposes an optical element, in particular an optical prism, for a vehicle window pane and/or a window pane laminate. The optical element comprises at least one light incoupling surface, a light guiding body and at least one light outcoupling surface, wherein the at least one light incoupling surface comprises at least one light diffuser layer and/or at least one double curvature. The light diffuser layer is preferably manifested such that the diffuse effect producible thereby results in scattering only in one spatial direction. “Barrel optical units” may be mentioned here by way of example. By contrast, a traditional diffuser layer scatters the light in all spatial directions.

It is understood that the light incoupling surface in principle can also comprise only one curvature about one axis and can additionally have the light diffuser layer. Moreover, the light incoupling surface can be formed as a plane surface and can comprise the light diffuser layer. The double curvature preferably defines a three-dimensional curvature of the light incoupling surface about at least two axes of extent of the optical element.

The inventors have thus recognized that by changing a shape of the light incoupling surface and/or by providing a diffuser layer, an angle of incidence of the light on the light incoupling surface can be increased. In this case, the shape of the light incoupling surface is adapted in relation to the shape for known optical elements to the effect that the light incoupling surface that is shaped concavely (as viewed proceeding from the light source) in the prior art additionally comprises a convex curvature, that is to say thus a double curvature. The light incoupling surface is thus complexly shaped and in the present case preferably has two mutually different curvatures, which preferably differ with regard to their respective reference axis. By virtue of the fact that the angle of incidence of the light on the light incoupling surface is changed on account of the complexly curved surfaces and/or on account of the diffuser layer, the incoupling angle of the light into the light guide layer increases, such that in contrast to the prior art homogeneous light intermixing can be attained, preferably directly upon or after the light incoupling. According to the invention, therefore, by virtue of the provision of an additional curvature, which did not yet exist in the prior art, and/or by virtue of the provision of the diffuser layer on and/or at the surface of the light incoupling surface, the light incoupling surface is modified to the effect that a larger incoupling angle can be attained. If the optical element is produced from PMMA or from PP U, for example, the incoupling angle, unlike in the prior art, is no longer limited to 41° to 42° (measured with respect to an angle bisector), but rather is increased in comparison there with by virtue of the further curvature and/or diffuser layer.

According to the invention, therefore, increased costs for light sources and/or an increased installation space requirement do(es) not arise. According to the invention it is likewise possible to reduce the light losses during the incoupling of light into the optical element and the outcoupling from the optical element into the light guide layer. According to the invention, overall, it is possible to attain better, in particular more homogeneous, color intermixing within the light guide layer, in particular already directly after the light outcoupling from the optical element, which serves for light incoupling into the light guide layer. The central concept of the invention consists in attaining a scattering effect and/or a microlens structure for scattering and/or expanding light from a light source by way of the double curvature and/or by way of the diffuser layer. This makes it possible to widen an emission angle in at least one emission direction in comparison with the prior art.

In comparison with the prior art, the embodiment of the optical element according to the invention thus encompasses a large number of advantages. In this regard, in the prior art it was only possible for light to be incoupled into a prism via a flat incoupling surface thereof facing the light source. This kind of incoupling was previously associated with the problem of deficient light intermixing, in particular at the edge side, which stemmed from the construction of conventional light sources, in particular LEDs. This is because such an LED generally consists of red-green-blue-emitting chips arranged in a row. The colors of these chips are mixed in order to obtain the desired combined (light) color. In general, this light mixing takes place over a specific distance or within a specific distance downstream of the light source. In other words, the light is not mixed directly after having been emitted, but rather only at a certain distance in front of the light source.

On account of these physical circumstances, in the prior art there was the problem that the mixing length or distance was too long, which is why light intermixing did not take place until after the light had emerged from the prism known in the prior art. This had the consequence that inhomogeneous colors could previously be seen in a boundary region between the prism and the light guide layer. As a result, an optical disturbance variable was previously caused, which was undesirable for an observer. However, this disadvantage has been able to be overcome by the present invention.

This is because by providing the double curvature and/or by providing the diffuser layer on the light incoupling surface of the optical element, the inventors have succeeded in preventing the deficient light intermixing in a boundary region between the optical element and a light guide layer into which light is incoupled via the optical element, such that homogeneous light intermixing can be provided even in said boundary region. This is achieved according to the invention by the provision of the double curvature, in particular by the provision of a concave curvature along an axis of the optical element. Alternatively or supplementarily, it is achieved by the provision of the diffuser layer. The concave lens shape preferably serves for scattering and/or further fanning out the light, as viewed in a main emission direction (x-direction), over a width of the optical element. This is preferably achieved by increasing the scattering of the light at the light incoupling surface. Greater scattering of the R-G-B light cones then preferably results in shortening of the mixing length. What can be achieved as a result is that the light is already intermixed within the optical element or at least upon emerging or upon transition from the optical element into the light guide layer. Preferably, therefore, light intermixing takes place earlier than was the case in the prior art. The earlier light intermixing is attained by the provision of the double lens and/or the diffuser layer. Therefore, according to the invention, the more particularly complete intermixing still takes place in a region that is not visible to the customer or user. This region can also extend into the non-visible region of the light guide layer.

In this case, the provision of the diffuser layer is an alternative or supplementation that can find application instead of or with the double curvature. The provision of the diffuser layer may possibly be simpler and more cost-effective in production, since the double curvature requires a complex injection mold, under certain circumstances. In addition, positioning of the optical element with double curvature, for example within an adhesive bonding tool, may possibly be more complicated and hence make it more difficult to mount the optical element on the light guide layer. This may be caused by the fact that the complexly curved surface of the optical element cannot be used or can only be used in a complicated manner as a stop for the placement in a tool. Moreover, in the case of the double curvature, in part on account of the surface curvature, it may transpire that the distance between the complexly curved incoupling surface and the at least one light source, which in particular can have individual red-green-blue chips, is not constant. The optical element with double curvature may therefore possibly be more sensitive to positioning tolerances during mounting. These challenges that exist in the case of the optical elements with double curvature according to the invention do not exist in the case of optical elements with a diffuser layer. However, owing to its optical properties, the double curvature also affords the advantages mentioned above, and so overall it constitutes a balanced alternative or supplementation to the diffuser layer.

The present invention thus relates to an optical element which results in shortening of a color mixing length within an optical element, in particular within a prism optical unit, which is used for incoupling light into a vehicle window pane for ambient lighting. In this case, the diffuser layer and/or the double curvature are/is structured so as to scatter the light asymmetrically, predominantly over an entire width of the optical element. In this case, on account of the shorter color mixing length achievable according to the invention, it is possible to use optical elements having smaller dimensions, whereby installation space can be saved. This has the consequence of using less installation space or area underneath a vehicle window pane at which the at least one optical element is intended to be fitted. The concept according to the invention can particularly preferably be formed and/or combined with an arbitrarily shaped surface geometry.

In one preferred embodiment, the at least one light incoupling surface extends along a longitudinal axis and along a transverse axis. The longitudinal axis and the transverse axis are preferably oriented orthogonally to one another and in each case orthogonally to a normal axis of the at least one light incoupling surface. The transverse axis preferably substantially, i.e. taking into account a deviation of ±20%, forms a normal to the light outcoupling surface. In this case, the double curvature preferably comprises a concave curvature about the transverse axis and a convex curvature about the longitudinal axis. The designation of the curvatures preferably relates to a viewing direction from the viewpoint of the optical element.

In one preferred embodiment, the normal axis forms an axis of symmetry with respect to the doubly curved light incoupling surface. In this case, the axis of symmetry can be and/or coincide with a cone center axis of an emission cone of the at least one light source. The normal axis can also form an axis of symmetry with respect to the light diffuser layer. The normal axis-relative to a surface central point of the light incoupling surface-preferably describes a surface central normal axis, i.e. a normal to the light incoupling surface which runs through the central point thereof. The central point can be a surface central point in one surface dimension or a surface central point relative to both surface dimensions.

In one preferred embodiment, the convex curvature and the concave curvature are designated along, or are related to, a main incoupling direction of light, the main incoupling direction being oriented parallel to the normal axis. The main incoupling direction preferably designates a cone center axis and/or an axis of symmetry of the emission cone of the at least one light source.

In one preferred embodiment, the light incoupling surface forms a collimator lens shaped concavely about the transverse axis and shaped convexly about the longitudinal axis. The collimator lens enables the light incoupled via the light incoupling surface to be aligned.

In one preferred embodiment, the light diffuser layer comprises an optical scattering structure, which preferably has structured and/or unstructured optical imperfections and/or an optical grating structure and/or a BRAG grating and/or optical scattering locations and/or optical scattering particles and/or a multiplicity of micro- and/or nanolenses. Other embodiments are also conceivable, in principle.

In one preferred embodiment, light scattering in at least one predetermined spatial direction is determined by the light diffuser layer, in particular the optical scattering structure and/or the double curvature.

In one preferred embodiment, the light diffuser layer comprises a light diffuser film applied to the light incoupling surface. Alternatively or supplementarily, the light diffuser layer is applied to the light incoupling surface by embossing and/or printing and/or vapor deposition and/or is produced by heating of a surface of the light incoupling surface. In principle, the light diffuser layer can also be applied to a film, in particular to a lamination film, by embossing and/or printing and/or vapor deposition and/or coating, wherein the film is in turn applied on the light incoupling surface.

In one preferred embodiment, the optical element can be produced or formed by injection molding. The scattering structure is preferably produced during the injection molding step by virtue of the scattering structure being present on the surface of the tool, in particular as a negative mold. The surface of the tool can be structured for example by laser etching, lithography, electroforming and/or printing.

The invention furthermore relates to a vehicle window pane and/or a window pane laminate on which at least one optical element according to any of the exemplary embodiments mentioned above and yet to be explained below is arranged.

Moreover, the invention is concerned with an optical system. The optical system comprises at least one optical element according to any of the exemplary embodiments mentioned above and yet to be explained below and at least one light source, in particular an LED light source. The at least one light source is configured to emit light which is incouplable into the optical element via the light incoupling surface, wherein the incoupled light is guidable to the light outcoupling surface via the light guiding body and is outcouplable from the light outcoupling surface. The light source is preferably configured to emit light at an emission angle that is preferably predefined by physical parameters of the light source. The emission angle and/or a distance between the light source and the light incoupling surface are/is preferably chosen and/or determined in such a way that light can be incoupled into the light incoupling surface over an entire longitudinal extent of the optical element, as viewed in the direction of the longitudinal axis.

The invention is likewise concerned with providing a vehicle window pane and/or a window pane laminate, comprising a light guide layer and at least one optical system in an embodiment mentioned above, wherein the at least one optical element is arranged on a side, in particular on an inner side, of the light guide layer, such that light outcoupled from the light outcoupling surface is incouplable into the light guide layer

The vehicle window pane and/or the window pane laminate according to the invention can in principle be arranged at any desired point of a motor vehicle and be designed for various use purposes.

It is understood that the embodiments and exemplary embodiments mentioned above and those yet to be explained below are implementable not only individually but also in any desired combination with one another, without departing from the scope of the present invention. It is likewise understood that the embodiments and exemplary embodiments mentioned above and those yet to be explained below equivalently or at least similarly relate to all embodiments of the invention, without being mentioned separately in each case.

Embodiments of the invention are illustrated schematically in the drawings and are explained by way of example below. In the drawings:

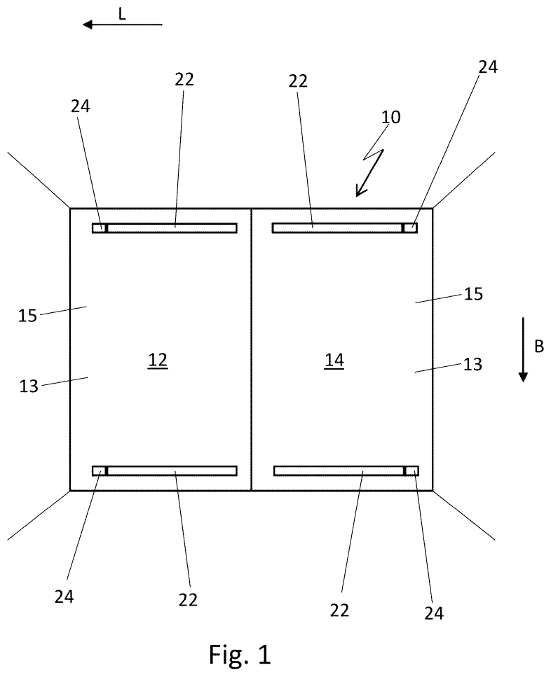

FIG. 1 shows a vehicle window pane comprising a plurality of optical elements;

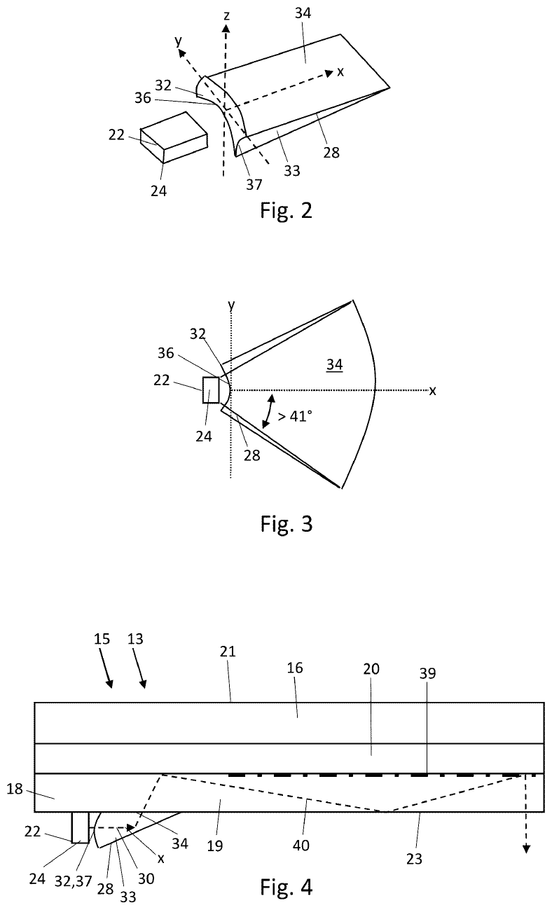

FIG. 2 shows a first exemplary embodiment of an optical element with a schematically indicated light source;

FIG. 3 shows a plan view of the optical element illustrated in FIG. 2;

FIG. 4 shows a sectional view through an exemplary vehicle window pane and through an exemplary optical element;

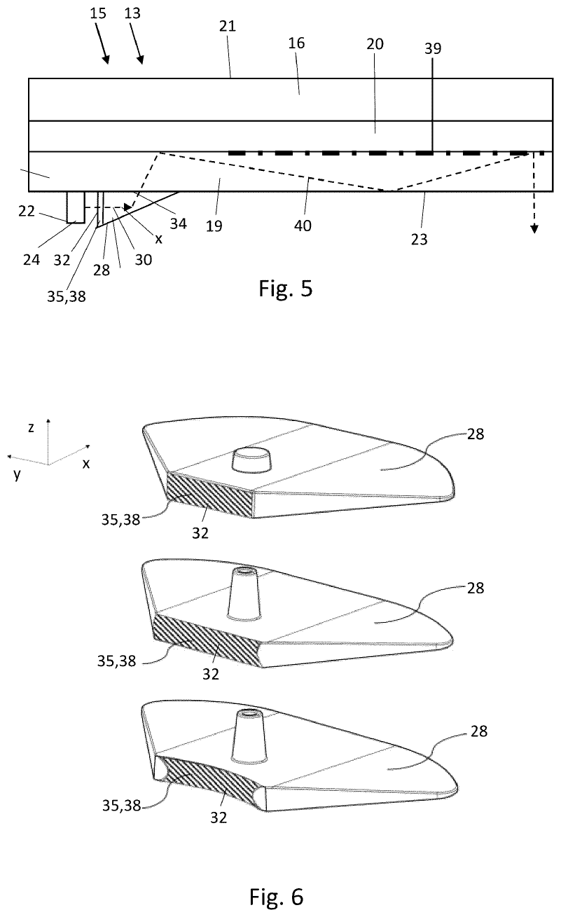

FIG. 5 shows a second exemplary embodiment of an optical element with a schematically indicated light source;

FIG. 6 shows a third exemplary embodiment of an optical element in three different variations;

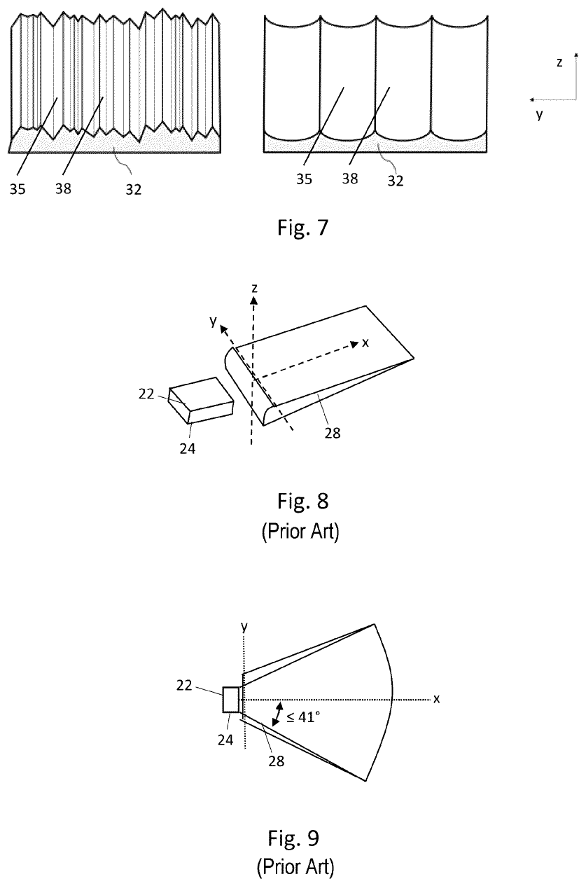

FIG. 7 shows a fourth exemplary embodiment of an optical element in two different variations;

FIG. 8 shows an optical element from the prior art; and

FIG. 9 shows a plan view of the optical element from the prior art as shown in FIG. 8.

FIG. 1 shows a vehicle roof 10 of a motor vehicle, the rest of which is not illustrated in more specific detail. The vehicle roof 10 is by way of example a panoramic roof having an adjustable cover element 12 and a fixed roof element 14, which is fixedly or immovably connected to the vehicle bodywork. Both the cover element 12 and the fixed roof element 14 each comprise a vehicle window pane 15 and/or a window pane laminate. In the present case, each vehicle window pane 15 is in the form of laminated safety glass (LSG) provided with an ambient light functionality. In this regard, the construction of the cover element 12 corresponds to that of the fixed roof element 14. One exemplary construction of the vehicle window pane is illustrated in greater detail in FIG. 4.

The roof elements 12 and 14 each in the form of a vehicle window pane 15 each comprise a window pane body arrangement 13 comprising a window pane outer body 16 and a window pane inner body 18. The window pane outer body 16 is formed by way of example from a curved glass sheet manufactured from a colored soda lime glass, for example. It is also conceivable to form the window pane outer body 16 from a plastics element, for example a polycarbonate element. The window pane inner body 18 can likewise be manufactured from an inorganic glass, such as a soda lime glass, or a polymer, for example a polycarbonate. Furthermore, in the present context, the window pane inner body 18 forms a light guide layer 19, in the volume of which incoupled light propagates (see FIG. 4).

The window pane outer body 16 and the window pane inner body 18 are connected to one another via at least one lamination layer or connecting layer 20, which can be formed from a material such as PVB (polyvinyl butyral), EVA (ethylene vinyl acetate) or TPU (thermoplastic polyurethane). In addition, the connecting layer 20 can be clear or fully transparent or else colored. In the present case, the connecting layer 20 has a thickness of less than one millimeter, but can also have a different thickness.

The window pane outer body 16 and the window pane inner body 18, which in the present case each have a thickness of a few millimeters, form the window pane body arrangement 13 having an outer side 21 facing the vehicle surroundings, and having an inner side 23 facing the vehicle interior. On the inner side 23, the window pane body arrangement 13 is provided with respective illumination devices 22 on both sides relative to a vertical roof longitudinal central plane, the ambient light functionality being realized by said illumination devices.

In the present case, the illumination devices 22 each extend in a vehicle longitudinal direction L (see FIG. 1) and are arranged opposite one another in a vehicle width direction B on the respective lateral margins of the cover element 12 and of the fixed roof element 14. The illumination devices 22 each comprise at least one light source 24 comprising an LED arrangement, in particular an LED bar and/or an LED strip.

According to the invention, on the inner side 23 there is arranged at least one optical element 28 via which light emitted by the at least one light source 24 can firstly be redirected within the optical element 28 and then be incoupled into the light guide layer 19. The optical element 28 in the present case forms an optical prism which for example extends in a barlike manner over the length of the respective illumination device 22 and in the present case has a wedge-shaped or triangular cross-section (see FIGS. 2 and 4). The optical element 28 thus forms a prismatic body. The latter is preferably manufactured from a plastics material in accordance with an extrusion method or an injection molding method, wherein materials used can be in particular PMMA, PPU, PC (polycarbonate), PA (polyamide), COC (cycloolefin copolymer) and/or COP (cycloolefin polymer), the refractive indices of which are for example between 1.48 and 1.59. The optical element 28 can be fixed to the window pane body arrangement 13 or to the inner side 23 by way of an adhesive layer, for example. A pressure sensitive adhesive, a liquid optically clear adhesive, EVA, PVB, TPU, an epoxy adhesive or an acrylate adhesive can be used as material for the adhesive layer. An optical element 28 of this type makes it possible for the at least one light source 24 to be arranged laterally with a main emission direction or a main incoupling direction 30 in particular parallel to the inner side 23 (see FIG. 4). Specifically, by way of the optical element 28, the light from the light source 24 is preferably redirected and collimated or aligned and in this way incoupled into the light guide layer 19 via the inner side 23.

The at least one optical element 28 comprises at least one light incoupling surface 32, a light guiding body 33 and at least one light outcoupling surface 34. The light outcoupling surface 34 is adhesively bonded to the inner side 23 (see FIG. 4).

According to the invention, the light incoupling surface 32 comprises at least one light diffuser layer 35 (see FIG. 5) and/or at least one double curvature, i.e. is multiply curved, for example, wherein the individual curvatures preferably differ from one another. In accordance with one possible embodiment according to the invention, the at least one light incoupling surface 32 extends along a longitudinal axis y and along a transverse axis z. The longitudinal axis y and the transverse axis z here are oriented orthogonally to one another and in each case orthogonally to a normal axis x of the at least one light incoupling surface 32. According to the invention, the double curvature is formed by a concave curvature 36 about the transverse axis z and a convex curvature 37 about the longitudinal axis y, wherein this should be considered in each case proceeding from the light source 24 along the main emission direction 30. The normal axis x forms an axis of symmetry with respect to the doubly curved light incoupling surface 32; see FIG. 3. In the case of FIG. 4, the main emission direction 30 is oriented parallel to the normal axis x.

In accordance with FIG. 5, an embodiment is shown in which the light incoupling surface 32 comprises the light diffuser layer 35. The light diffuser layer 35 in turn comprises an optical scattering structure 38. The optical scattering structure 38 can be formed by a light diffuser film applied to the light incoupling surface 32. The optical scattering structure 38 is illustrated in greater detail by way of example in FIGS. 7 and 8. Alternatively or supplementarily, the optical scattering structure 38 and/or the light diffuser layer 35 can be applied to the light incoupling surface 32 by embossing and/or printing and/or vapor deposition and/or can be produced by heating of a surface of the light incoupling surface 32. The optical scattering structure 38 preferably has structured and/or unstructured optical imperfections and/or an optical grating structure and/or a BRAG grating and/or optical scattering locations and/or optical scattering particles and/or a multiplicity of micro- and/or nanolenses. Light scattering in at least one predetermined spatial direction x, y, z is determined by the optical scattering structure 38 and/or the double curvature, an emission angle being widened in comparison with the prior art (see according to the invention >41° versus ≤41° in the prior art). As can be gathered purely schematically from FIG. 5, the light incoupling surface 32 does not comprise a double curvature. By way of example, as known in the prior art, the light incoupling surface 32 can be just singly curved in order in this way to align and/or focus and/or concentrate the light. Particularly preferably, the light diffuser layer comprises an optical scattering structure that scatters light substantially or predominantly along the y-direction and only slightly or minimally in the z-direction. By way of the scattering structure, therefore, the light is preferably scattered in the y-direction, whereas no or only minimal scattering occurs in the z-direction.

As is evident schematically from FIGS. 4 and 5, the light source 24 is configured to emit light at a predetermined emission angle, said light being incoupled into the optical element 28 via the light incoupling surface 32. The incoupled light is guided by the light guiding body 33 to the light outcoupling surface 34 and is outcoupled from the light outcoupling surface 34 into the light guide layer 19. The light spreads out within the light guide layer 19, an exemplary light path being identified by the reference numeral 40, and is outcoupled through a light outcoupling layer 39 from the light guide layer 19 for example into an interior of a vehicle and/or some other space.

FIG. 6 shows a further exemplary embodiment of an optical element 28 in three different embodiments. The embodiments differ, as viewed from top to bottom, in the type and shaping of the light incoupling surface 32. The upper light incoupling surface 32 of the three embodiments from FIG. 6 is not curved, but rather comprises-in order to provide the scattering according to the invention-just the light diffuser layer 35 with the optical scattering structure 38 indicated schematically by hatching. The middle view in FIG. 6 shows a light incoupling surface 32 comprising a single curvature about the y-axis and also the light diffuser layer 35 with the optical scattering structure 38 indicated schematically by hatching. The curvature is convex proceeding from the optical element. In accordance with the lower embodiment of the optical element 28 in FIG. 6, the light incoupling surface 32 comprises the double curvature according to the invention and also the light diffuser layer 35 with the optical scattering structure 38 indicated schematically by hatching, i.e. a combination of both possibilities according to the invention.

FIG. 7 illustrates two close-up views or detailed views of a light diffuser layer 35, the optical scattering structure 38 being different in these views. By way of example, in the left-hand illustration, the optical scattering structure 38 is introduced into the surface of the light incoupling surface 32 of the optical element 28 by a laser and has asymmetric indentation with different heights along the y-axis. In the right-hand illustration of the light diffuser layer 35 of the light incoupling surface 32, the optical scattering structure 38 has a symmetric, wavy course along the y-axis. In principle, the light diffuser layer 35 and/or the optical scattering structure 38 can be a linear diffuser. In this case, it is preferred if the light is scattered and/or fanned out primarily in the y-direction by the light diffuser layer 35, but such scattering does not take place or takes place only minimally in the z-direction. The optical scattering structure 38 can be a micro- or nanostructure. Particularly preferably, the optical scattering structure 38 is molded into the optical element 28 by way of a negative mold in an injection molding tool. Alternatively or supplementarily, the optical scattering structure 38 is produced by way of laser structuring. Alternatively or supplementarily, the optical scattering structure 38 is shaped into the light incoupling surface 32 by way of lithographic electroforming or embossing or a washer.

### LIST OF REFERENCE SIGNS

10 Vehicle roof
12 Cover element
13 Window pane body arrangement
14 Fixed roof element
15 Vehicle window pane
16 Window pane outer body
18 Window pane inner body
19 Light guide layer
20 Connecting layer
21 Outer side
22 Illumination device
23 Inner side
24 Light source
28 Optical element
30 Main emission direction or main incoupling direction
32 Light incoupling surface
33 Light guiding body
34 Light outcoupling surface
35 Light diffuser layer
36 Concave curvature
37 Convex curvature
38 Optical scattering structure
39 Light outcoupling layer
40 Light path
B Vehicle width direction
L Vehicle longitudinal direction
X Normal axis
y Longitudinal axis
Z Transverse axis

1. An optical element (28), comprising at least one light incoupling surface, a light guiding body and at least one light outcoupling surface, characterized in that the at least one light incoupling surface comprises at least one light diffuser layer and/or at least one double curvature.

2. The optical element as claimed in claim 1, characterized in that the at least one light incoupling surface extends along a longitudinal axis y and along a transverse axis z, wherein the longitudinal axis y and the transverse axis z are oriented orthogonally to one another and in each case orthogonally to a normal axis x of the at least one light incoupling surface, wherein the transverse axis z substantially forms a normal to the light outcoupling surface, and wherein the double curvature comprises a concave curvature about the transverse axis z and a convex curvature about the longitudinal axis y.

3. The optical element as claimed in claim 2, characterized in that the normal axis x forms an axis of symmetry with respect to the doubly curved light incoupling surface.

4. The optical element as claimed in claim 2, characterized in that the convex curvature and the concave curvature are designated along a main incoupling direction of light, the main incoupling direction being oriented parallel to the normal axis x.

5. The optical element as claimed in claim 2, characterized in that the light incoupling surface forms a collimator lens shaped concavely about the transverse axis z and shaped convexly about the longitudinal axis y.

6. The optical element as claimed in claim 1, characterized in that the light diffuser layer comprises an optical scattering structure, which preferably has structured and/or unstructured optical imperfections and/or an optical grating structure and/or a BRAG grating and/or optical scattering locations and/or optical scattering particles and/or a multiplicity of micro- and/or nanolenses.

7. The optical element as claimed in claim 1, characterized in that light scattering in at least one predetermined spatial direction x, y, z is determined by the light diffuser layer and/or the double curvature.

8. The optical element as claimed in claim 1, characterized in that the light diffuser layer comprises a light diffuser film applied to the light incoupling surface, and/or in that the light diffuser layer is applied to the light incoupling surface by embossing and/or printing and/or vapor deposition and/or is produced by heating of a surface of the light incoupling surface.

9. A vehicle window pane and/or a window pane laminate on which at least one optical element as claimed in claim 1 is arranged.

10. An optical system, comprising at least one optical element as claimed in claim 1 and at least one light source, wherein the light source is configured to emit light which is incouplable into the optical element via the light incoupling surface, wherein the incoupled light is guidable to the light outcoupling surface via the light guiding body and is outcouplable from the light outcoupling surface.

11. A vehicle window pane and/or a window pane laminate, comprising a light guide layer and at least one optical system as claimed in claim 10, wherein the at least one optical element is arranged on a side of the light guide layer, such that light outcoupled from the light outcoupling surface is incouplable into the light guide layer.

12. The optical element as claimed in claim 7, characterized in that light scattering in at least one predetermined spatial direction x, y, z is determined by the optical scattering structure.

13. The optical system as claimed in claim 10, wherein the at least one light source comprises an LED light source.
